(19) United States
(12) Patent Application Publication
(10) Pub. No.: US 2008/0208566 A1
(43) Pub. Date: Aug. 28, 2008

(54) Automated word-form transformation and part of speech tag assignment

(75) Inventor: Siarhei Alonichau, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/710,189

(22) Filed: Feb. 23, 2007

(51) Int. Cl. G06F 17/27

(52) U.S. Cl. 704/9

(57) ABSTRACT

A method of creating a data structure for use with a morphological algorithm is discussed. The method includes creating a data structure having a plurality of paths. The data structure maps a plurality of words into a set of classes. The method further includes modifying the data structure to remove a portion of one or more of the paths that is not necessary to unambiguously map the words to the set of classes and storing the data structure on a tangible computer readable medium.

### BACKGROUND

In a number of computer or textual processing applications, information about a particular word-form and/or part of speech of a given word is used to perform a variety of tasks depending on the nature of the application. One particular type of textual processing application is known as “grammar checker”. A grammar checker receives textual input from, for example, a word processor, and determines whether the textual input has any discernable grammatical problems. Such an application may check to make sure that there is agreement in number between a subject and a verb in a sentence. The grammar checker may also check for a variety of other grammatical problems, such as agreement in verb subject person, verb tense (such as in a compound sentence). In highly morphological languages, a grammar checker may also check the agreement between number, case, and/or gender of words such as nouns and modifying adjectives. Should the grammar checker find possible grammatical problems, the grammar checker will typically provide suggested changes for a user to consider.

Another example of an application that is known to use word-form and/or part of speech information related to an input word or words is a search engine system that searches for exact and related matches to the given input. Such a search engine requires that the input be processed to provide words or phrases that are similar to the actual input. For example, a search term that includes a noun modified by an adjective may, depending upon the language, provide several combinations that include variations in number, case, and/or gender to a search engine to search a particular database or network. Other examples of an application that typically uses word-form and/or part of speech information related to an input word or words is a machine translation system for translating an input in one language into another language or an electronic thesaurus.

One approach to providing word-form and part of speech (POS) data for use in applications like those discussed above is to use a predefined dictionary that links all “known words” and their inflections, lemmas, and/or POS tags. For the purposes of this discussion, the phrase “known words” describes words that are in the dictionary. However, using such a dictionary in such applications presents challenges. For example, the large number of inflections present in morphologically rich languages results in dictionary-based solutions that consume a large amount of memory, which can be problematic if memory size is an issue.

Even with a very large dictionary, out of vocabulary words, that is, words that are not known words can cause errors. As a result, a rule-based morphological system is also often employed to account for words and their associated word-forms or inflections that are not located within the dictionary. However, such rule-based morphological systems can be costly and difficult or at least time-consuming to develop and maintain. Furthermore, dictionary-based solutions with a morphological system to accommodate out of vocabulary words can have poor runtime performance.

The discussion above is merely provided for general background information and is not intended to be used as an aid in determining the scope of the claimed subject matter.

### SUMMARY

In one embodiment, a method of creating a data structure for use with a morphological algorithm is discussed. The method includes creating a data structure having a plurality of paths. The data structure maps a plurality of words into a set of classes. The method further includes modifying the data structure to remove a portion of one or more of the paths that is not necessary to unambiguously map the words to the set of classes and storing the data structure on a tangible computer readable medium.

In another embodiment, a method of providing morphological information to a computer implemented application is discussed. The method includes receiving an input signal indicative of a word. The method further includes selecting a piece of morphological class data from the finite state automaton-based data structure that is mapped to a location in the data structure associated with at least a portion of the word. The method further includes providing the morphological class data to an application without accessing a dictionary.

In still another embodiment, a tangible computer medium is discussed. The tangible computer medium stores a system adapted to perform automated morphological operations on an input. The system includes first and second finite state automaton-based data structures having a plurality of paths that maps a dictionary of words into a set of classes. The first finite state automaton-based data structure has a plurality of paths that maps a dictionary of words into a set of classes, wherein at least one of the paths is shorter than the word that is mapped to it. The system further includes an algorithm configured to access the data structure to retrieve data related to the sets of classes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram illustrating a system for receiving a textual input and providing an output related a morphological task performed on the input to an application according to one illustrative embodiment.

FIG. 2A is a table representing an exemplary dictionary of words including information related to part of speech tags associated with each word in the dictionary.

FIG. 2B is a table representing another exemplary dictionary of words including information related to word form translations associated with each word in the dictionary.

FIG. 3A illustrates a method of creating data structures for use in the performance of the morphological tasks by the system of FIG. 1 according to one illustrative embodiment.

FIG. 3B illustrates a method accessing the system of FIG. 1 to receive data from data structures related to in input word according to one illustrative embodiment.

FIG. 4A-D illustrates deterministic finite-state automata data structures assigning a set of part of speech classes for the dictionary of FIG. 2 in progressive states of creation according to one illustrative embodiment.

FIG. 5 illustrates a generalized form of the data structure of FIG. 4D according to one illustrative embodiment.

FIG. 6 illustrates a generalized form of the data structure of FIG. 5 according to one illustrative embodiment.

FIG. 7 illustrates a finite-state automaton data structure assigning a set of word-form transformation classes for the dictionary of FIG. 2 according to one illustrative embodiment.

FIG. 8 is a block diagram of one computing environment in which some embodiments may be practiced.

### DETAILED DESCRIPTION

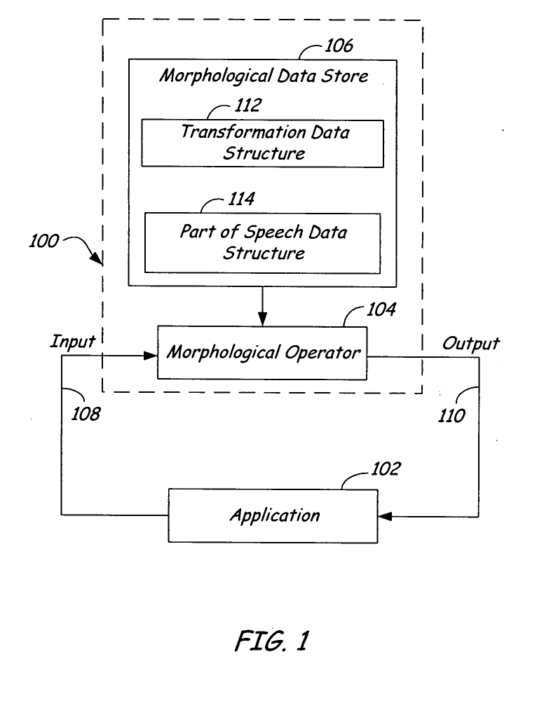

FIG. 1 illustrates a morphological system 100 in communication with an application 102 for performing one or more morphological operations on an input 108 from the application 102 according to one illustrative embodiment. Application 102 can be any one of a number of different types of applications that work with textual inputs. For example, application 102 can be a thesaurus or a grammar checker for use with a word processor. Other applications can include a machine translation system, a speech to text system, a text search engine system, and the like. Input 108 is, in one illustrative embodiment, a text input. The text input is a single word or a word and its POS tag. Alternatively, the text input can be a phrase or other multi-word expression.

The input 108 is provided to the morphological system 100 and the morphological system 100 provides an output 110 back to the application 102. Output 110 is a set of words or a set of POS tags depending on the morphological operation. The morphological system 100 has a morphological operator 104, which illustratively includes algorithms to perform any number of different types of morphological operations such as the operations described below. The morphological operator 104 receives information for a morphological data store 106. From the information provided by the morphological data store 106, the morphological operator 104 analyzes the input 108 provided by the application 102. Depending upon the type of operation to be performed by the morphological operator 104, the output 110 returned to the application 102 can take on a variety of different forms. The details of the information provided by the morphological data store 106 will be discussed in more detail below.

As discussed above, the morphological operator 104 can provide a number of different morphological operations. A first morphological operation that can be performed by the morphological operator 104 is known as a word-to-tags or “W2T” operation. The W2T operation receives a given input word 108 and provides as an output 110 a list of parts of speech (POS) tags, which indicate all of the different parts of speech that the given input word can be. As an example, the word “building” is both a singular noun and a present participle.

A second morphological operation that is illustratively performed by the morphological operator 104 is known as word-to-base operation or “W2B”. The W2B operation provides, for a given input word, all of the lemmas or base words of the given word. For example, the word “building” in English would return the words “building” and “build.” Returning each of the lemmas “building” and “build” recognizes that “building” can be a noun as well as a form of a verb and therefore provides both lemmas as an output 110 for the “W2B” operation.

A third morphological operation that is illustratively performed by the morphological operator 104 is known as a word-to-word operation or “W2W”. The W2W operation provides as an output 110 all of the inflections of the given word provided by input 108. A fourth morphological operation, known as word-and-tag-to-base operation or “WT2B”, receives as an input a word and its part of speech tag and provides as an output the lemma associated with the part of speech of the given input word. For example, if the word “building” is provided along with the tag VBG (which represents a present participle), the word “build” would be returned, as that is the base word or lemma of the verb “building.”

A fifth morphological operation, known as word-and-tags-to-word operation or “WTT2W”, receives, as an input, a given word, its part of speech tag, and a destination part of speech tag. The output 110 provided by the system 100 is the word that corresponds to the destination part of speech tag and the input word. It is to be understood, as discussed above, that algorithms to perform other morphological operations can be provided without limitation. Other examples of morphological operations include a base-to-tag, or “B2T”, operation, which returns a set of POS tags representing a morphological paradigm for a given base-form word. Yet another operation is known as base-to-word operation, or “B2W”, in which all word forms for a given base form word are returned. Still another morphological operation is known as base-and-tag-to-word operation, or “BT2W”. The BT2W operation provides a set of corresponding words for an input of a base-form word and destination POS tags.

The morphological data store 106 illustratively includes a list of transformation data structures 112 (one per morphological operation) and a list of part of speech data structures 114. Each of the transformation data structures 112 and the part of speech data structures 114 is a minimal deterministic finite-state model that models a dictionary of known words in the given language. Based on the particular operation to be performed by the morphological operator 104, the information in the transformation data structure 112 and/or the part of speech data structure 114 is traversed to provide an output for the given operation. For example, the W2T task will traverse the part of speech data structure 114 to find one or more parts of speech that correspond to the given input word.

As another example, the WT2B task requires that the morphological operator 104 traverse a data structure that combines both word letters and POS tag values. It should be appreciated that the morphological data store 106 can have alternative or additional data structures without departing from the spirit and scope of the discussion.

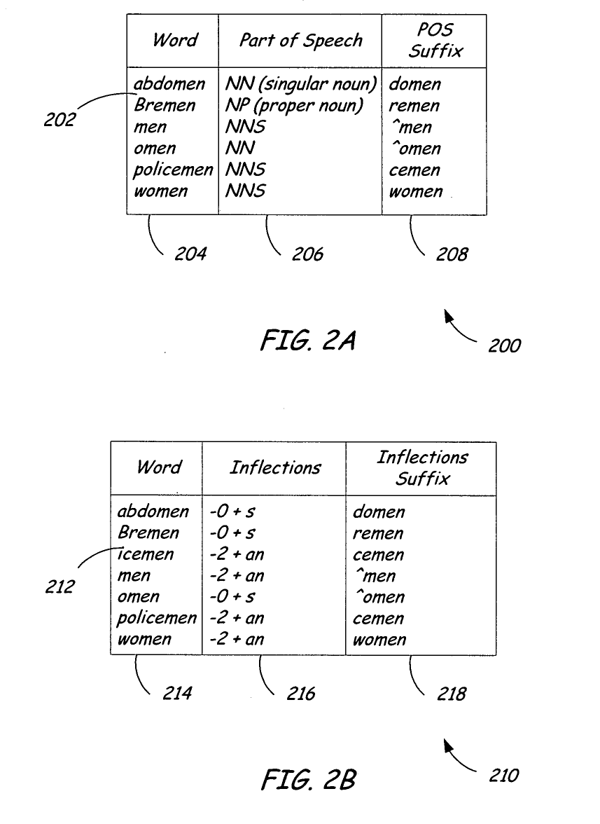

FIG. 2A illustrates a table 200, which includes a small dictionary 202 that will be referenced in the discussion of various embodiments below. Table 200 includes a word column 204 that lists words that are a part of the dictionary 202. Each of the words in column 204 ends with the letters “men”. In addition, each word in column 204 is associated with a part of speech tag in column 206. While each word in the column 204 has only one part of speech tag assigned to it, a larger dictionary can have words associated with any number of parts of speech tags. For example, as discussed above, the word “building” can be both a noun describing a type of structure or a participle form of the verb “to build”. Thus, if the word “building” were in the dictionary of table 200, the part of speech column 206 would include two different part of speech tags associated with the word “building”.

The dictionary 202 in table 200 includes only nouns. It is to be understood, of course, that other parts of speech may be included in the same dictionary without departing from the scope of the discussion. Even though each word in dictionary 202 is a noun, there are several different parts of speech represented in the part of speech column 206 of table 200. For example, the word “abdomen” is a singular noun. The part of speech tag “NN” (which is illustratively the tag for a singular noun) is associated with the word “abdomen” in column 206. Other types of nouns in column 204 of table 200 include “Bremen”, which is a proper noun (associated with the part of speech tag “NP”), and policemen, which is a plural noun (associated with the part of speech tag “NNS”).

The words stored in dictionary 202 are illustratively English words, but it should be appreciated that the embodiments discussed herein can be applied to other languages as well. To that end, nouns in other languages can be further classified in terms of a part of speech beyond whether a noun is singular, plural, or proper. For example, a particular noun in a language such as Spanish may have a different word-form to express gender. Thus, the word “cat” in English is a singular noun that is used to describe both male and female felines. However, in Spanish the word “gato” is a masculine singular noun for a male cat and the word “gata” is a feminine singular noun for a female cat. In other languages, different forms of a noun are used to represent case. For example, a noun that is used as the subject of a sentence, in some languages, is different from the noun used to show possession or be the object of the sentence. In various languages, then, different nouns can be used to represent, number, gender, and case. The discussion provided herein is in no way intended to limit any particular part of speech in any language. Each word in the dictionary 202 is also assigned a part of speech suffix in column 208. The purpose of the part of speech suffix column 208 will be discussed in more detail below.

FIG. 2B illustrates a table 210, which includes a dictionary 212. For the purposes of this discussion, the words stored dictionary 212 is slightly different than the dictionary 202, although in practice, the dictionaries can be identical. The table 210 includes a column 214, which stores words that are a part of the dictionary 212. In addition, the table 210 includes a column 216, which provides a list of inflections, or more precisely, word-form transformation instructions, for to transform each word of the dictionary 212 into an inflection. For example, the word “abdomen” is a singular noun having one inflection, the plural form of the word “abdomen”, which is “abdomens”. To obtain the word “abdomens” from the word “abdomen”, it is necessary to add an “s” to the end of the original word. This is illustratively represented in column 216 by the string “−0+s”, which means subtracting zero characters from the end of word and adding an “s”. In other languages it may be necessary to make a change from both sides of the word, in this case a transformation class is encoded as “−N+suff/−M+prefix” where N and M represent the number of characters to be substracted from the beginning and end of a word, respectively.

As another example, the word “icemen” has a single inflection, the singular form “iceman”. The transformation instructions for icemen are thus “−2+ an”, meaning that the final two letters of the word iceman are removed and “an” is added to the end of the word to form the inflection. While each word in column 202 has inflection associated with it, alternatively a word can have any number of inflections assigned to it. Each word in column 202 is also assigned an inflection suffix in column 216. The purpose of the inflections suffix will be discussed in more detail below.

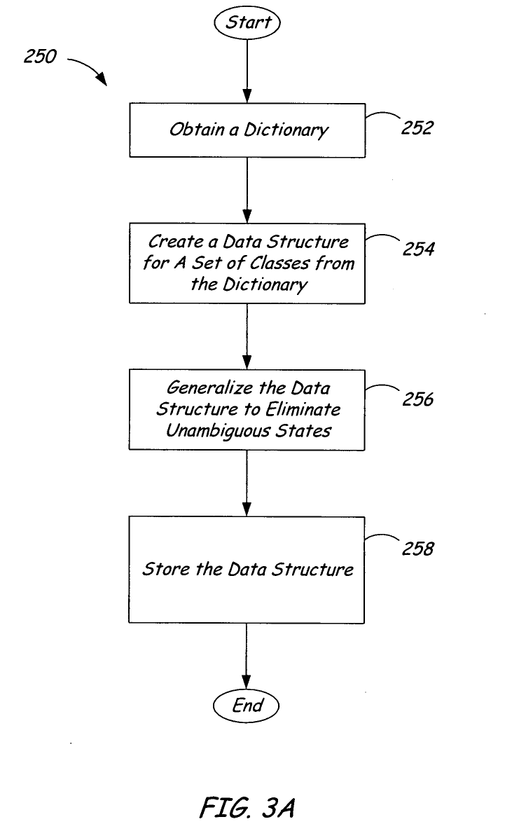

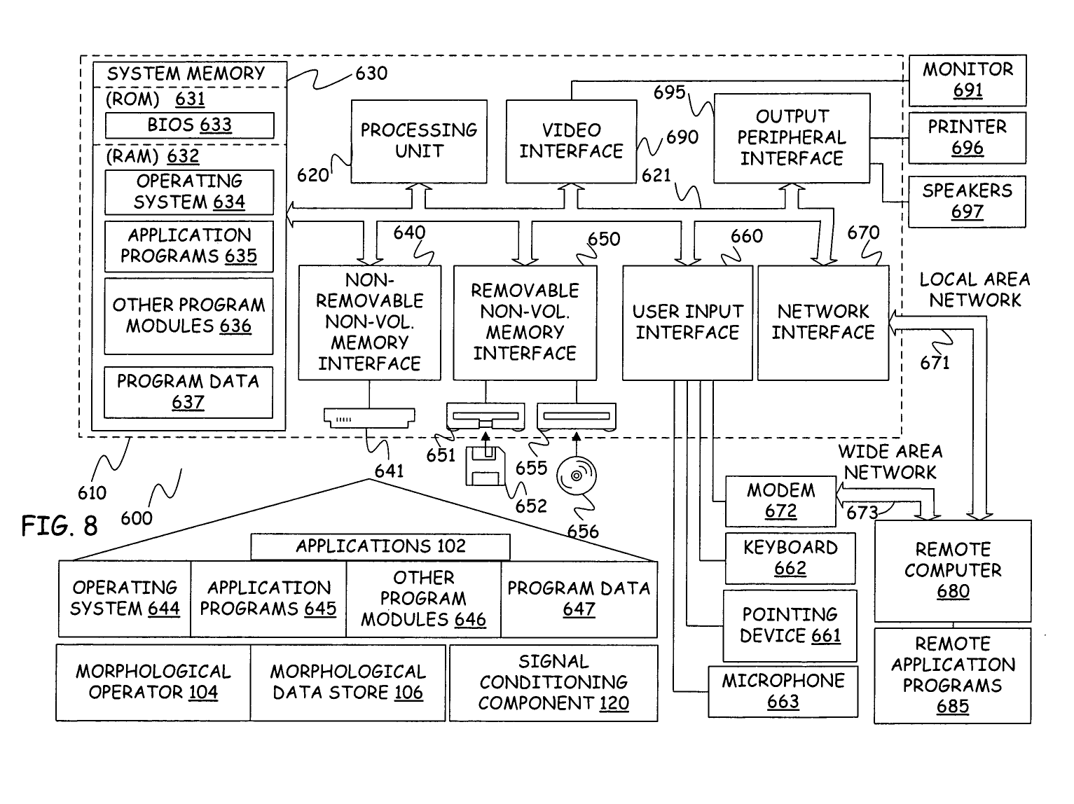

Referring to FIG. 3A, a method 250 of creating a data structure of the type stored in the morphological data store 106 (illustrated in FIGS. 1 and 8) is provided. Method 250 illustratively includes obtaining a dictionary of known words such as, for example, dictionary 202 (shown in FIG. 2A), which is illustratively represented in block 252. Once the dictionary is obtained, the method 250 includes creating a data structure corresponding to at least one set of classes related to the dictionary as is shown in block 254. The created data structure illustratively includes a plurality of paths that maps the words in the dictionary into a set of classes. In one embodiment, the provided data correspond to data structures in the morphological data store 106 (shown in FIG. 1). Examples of the data structures created by the method as represented by block 254 can include data related to parts of speech, inflections, or other types of data. It is to be understood that more than one data structure can be created for a particular dictionary, depending upon the different set of classes that are associated with the dictionary and the morphological operations that are capable of being performed by the system 100.

Once the data structure has been created, the data structure is illustratively modified to remove at least one of the plurality of paths by eliminating a portion of it that leads to an unambiguous result. This is represented by block 256. The data structure is then illustratively stored on an appropriate media. This is represented by block 258. Examples of different types of appropriate media are discussed in more detail below.

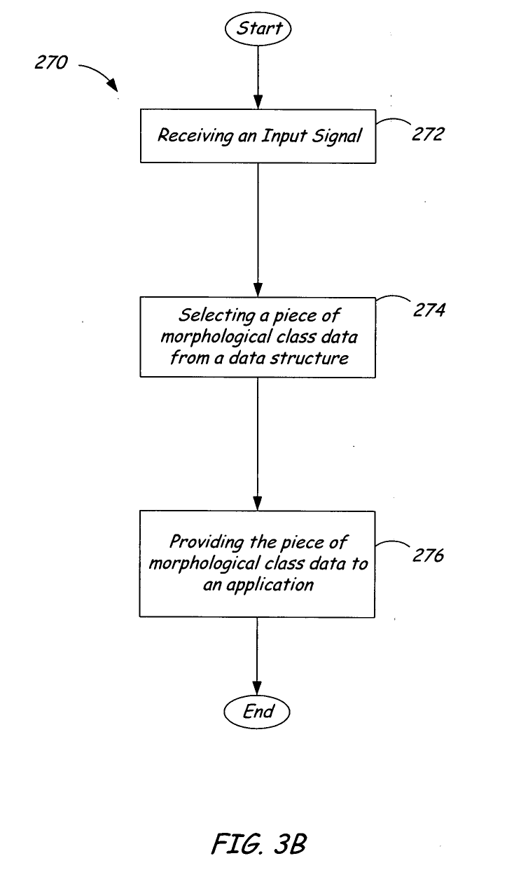

FIGS. 4A-4C illustrate various stages of a method of creating a data structure 370 shown in FIG. 4D as illustrated by block 254 of method 250 illustrated in FIG. 3A. Data structure 370 includes data related to a part of speech set of classes in. For the purposes of this discussion, data structure 370 illustratively corresponds to the part of speech data structure 114 shown in FIG. 1. It is to be understood, however, that a data structure corresponding to the transformation data structure 112 or any other data structure stored in the morphological data store 106. Furthermore, the methods discussed below can be incorporated to create, modify, or use any of the data structures stored in morphological data store 106.

Data structure 370 is illustratively created using the dictionary 202 provided in table 200 of FIG. 2B. In one illustrative embodiment, the part of speech data structure 370 is a finite-state automaton. More particularly, data structure 370 is a minimal deterministic automaton. In FIG. 4A, a partially created data structure 300 is shown. The data structure 300 illustrates a single word, abdomen, added to the part of speech data structure 300. The partial data structure 300 is illustratively created by traversing the word abdomen in the dictionary backwards from the end of the word to the beginning. The part of speech data structure 300 has an initial or starting node 302. A node 304 is connected to the initial node 302. The initial node 302 is connected to node 304 via a branch identified with an “n”. The “n” represents the last letter in the word abdomen. It should be noted here that other words that might be subsequently be added to the data structure and end in letters other than “n” would branch off of the initial node 302.

Additional nodes 306-316 are connected in series extending from node 304 by branches representing the letters of the word abdomen. A termination node 318 is connected to node 316 by a branch illustratively identified as a “̂”, which illustratively represents the beginning of the word abdomen and, in this case, the connection to termination node 318, which is simply a node at the end of a path. Termination node 318 is also illustratively associated the part of speech tag, “NN”. As is shown in FIG. 2, “NN” is the one part of speech tag associated with the word abdomen. While the partial data structure 300 shown here processes words right to left, alternatively words can be processed left to right without departing from the scope of the discussion.

FIG. 4B illustrates a partial data structure 320, which includes a second word, Bremen, added to the partial data structure 300. Because the word Bremen has the same last three letters as the word abdomen, the word Bremen shares the first three nodes 304, 306, and 308 after the initial node 302. Node 322 is connected to node 308 with a branch identified with an “e”. Nodes 324 and 326 are connected in series to node 322 via branches representing the letters “r” and “B”. Node 326 is connected to termination node 328, which represents the beginning of the word Bremen and is assigned the part of speech tag “NP”, because Bremen is a proper noun.

FIG. 4C represents a partial data structure 330 with each of the words in the dictionary shown in table 200 integrated therein. The word “men” is represented by a path created by nodes 302, 304, 306, 308 and by termination node 344. The word “policemen” is represented by a path created by nodes 302, 304, 306, 308, 322, 332, 334, 336, 338, 340 and by terminal node 342. The word “women” is represented by a path created by nodes 302, 304, 306, 308, 310, 348 and termination node 350. The word “omen” is represented by a path created by nodes 302, 304, 306, 308, 310, and termination node 346. A similar data structure is created to correspond with the transformation data class (not shown). The data structure 330 shown in FIG. 4C includes a plurality of paths that map each of the plurality of words of dictionary 200 into a set of classes related to part of speech.

As discussed above, once the data structure 330 has been created, the data structure 330 is generalized. That is, the data structure 330 is modified to remove a path that leads to an unambiguous result, that is, a path that leads to only one termination node. This is represented by block 256. FIG. 4D illustrates data structure 360, which is a modified version of data structure 330. As compared to FIG. 4C, it can be seen that a number of nodes have been removed. For example, in FIG. 4C, the word “abdomen” is represented by the path defined by nodes 302, 304, 306, 308, 310, 312, 314, 316, and a termination node 318.

However, a review of the completed part of speech data structure 300 reveals that once nodes 312-316 lead along an unambiguous path to termination node 318. Is reached, there is no ambiguity as to the final result to be achieved by further traversal down the path. Thus, the part of speech data structure 360 is generalized by eliminating nodes 312, 314, and 316 and attaching termination node 318 to node 310. Thus, when a word matches a “d” at node 310, the next node is the termination node 318. Alternatively, nodes 314, 316, and 318 can be eliminated, leaving node 312 as a termination node that is assigned the part of speech tag “NN”. In all of the subsequent discussion the prior method, that of eliminating intermediate nodes, is discussed, but it should be understood that either approach may be used without departing from the scope of the discussed embodiments.

It should be recognized from the foregoing example that it is not necessary, then, to traverse a path in the part of speech data structure 300 beyond a suffix of “domen” to know that the word is a singular noun. Furthermore, any time that the termination node 318 is reached, the output part of speech data structure 300 returns the “NN” part of speech tag. Thus, whenever a word ending in “domen” other than abdomen is provided as an input to the part of speech data structure 360, should one ever be encountered, would also result in a part of speech tag of “NN” being returned. Such a word would be an out of vocabulary word, in that it is not a word that was part of the original dictionary. Regardless, data structure 360 illustratively provides a part of speech tag “NN” for any word ending in “domen”. Because the word was not a part of the original dictionary used to create the data structure 360, the part of speech assigned would be a guess. In highly morphological languages, where words have similar endings or suffixes based on the part of speech, this can be a highly effective method of guessing a part of speech.

Without generalizing the data structure 330 to the form shown as data structure 360 in FIG. 4C, it would not be possible to guess parts of speech based on a suffix. This is because the only termination nodes in data structure 330, that is, nodes with part of speech tags associated with them, are those that point to the beginning of the word. Thus, only those words in the dictionary are, in fact, recognizable and no guessing can occur. In addition to allowing guessing of out of vocabulary words, every word that was in the dictionary used to create the data structure 360 receives a proper part of speech tag in the generalized part of speech data structure 360.

Returning briefly to FIG. 2A, column 208 of table 200 provides a “part of speech suffix” for each of the words in column 204. For example, the word Bremen has a part of speech suffix of “remen”. As is shown in FIG. 4C, nodes 324 and 326 lead to an unambiguous result. Therefore, nodes 324 are 326 are removed from the part of speech data structure 300 and node 322 is connected to termination node 328, which is assigned a “NP” part of speech tag.

Returning again to FIG. 4C, it can be seen that the path extending from node 332 is unambiguous. Therefore, nodes 332, 334, 336, 338, and 340 are removed and node 328 is turned into a termination node 342 is attached to node 322. Similarly, all other nodes that lead to an unambiguous result are removed, leaving the part of speech data structure 360 as is shown in FIG. 4D.

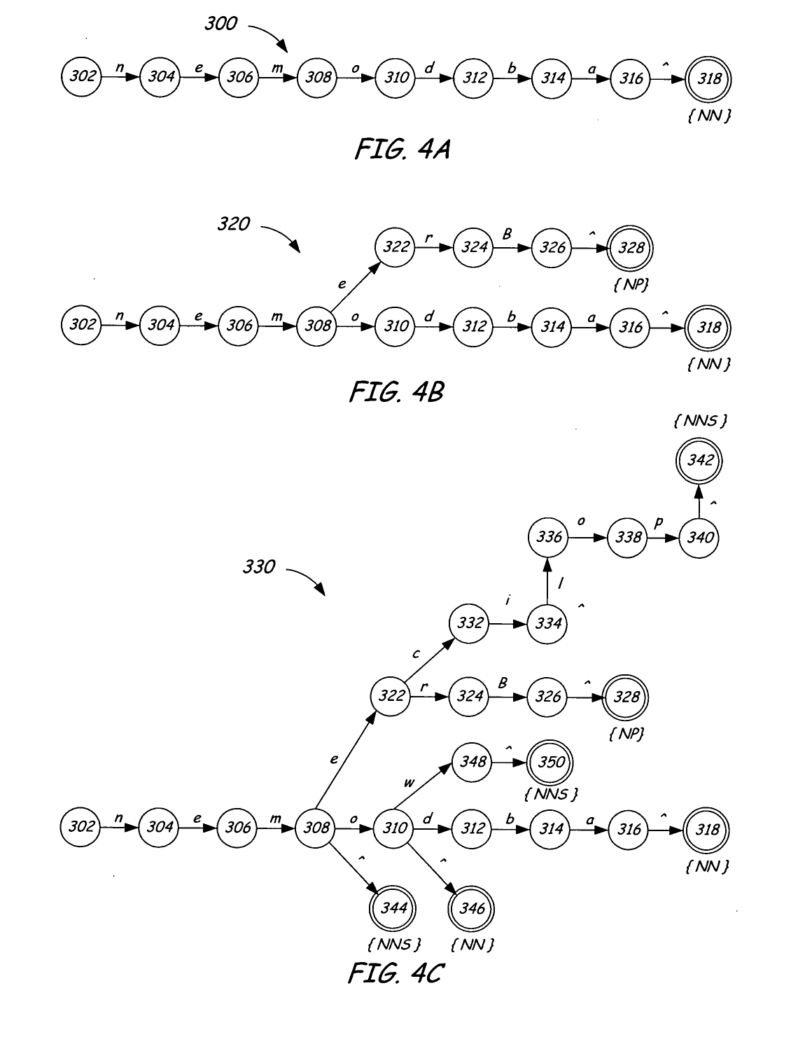

FIG. 5 illustrates a generalized version of the data structure 300 of FIG. 4D, in the form of a minimal deterministic automaton, according to one illustrative embodiment. In the data structure 370 shown in FIG. 5 a single termination node is provided for each possible POS tag. For example, in the data structure 360 in FIG. 4D, termination nodes 328, 334 and 346 are each associated with a “NNS” POS tag. In the data structure 370, only one termination node, 350, is associated with an “NNS” tag. Therefore, all nodes that come to the result of “NNS” branch to termination node 350. This advantageously results in a smaller data structure than that shown in FIG. 4D.

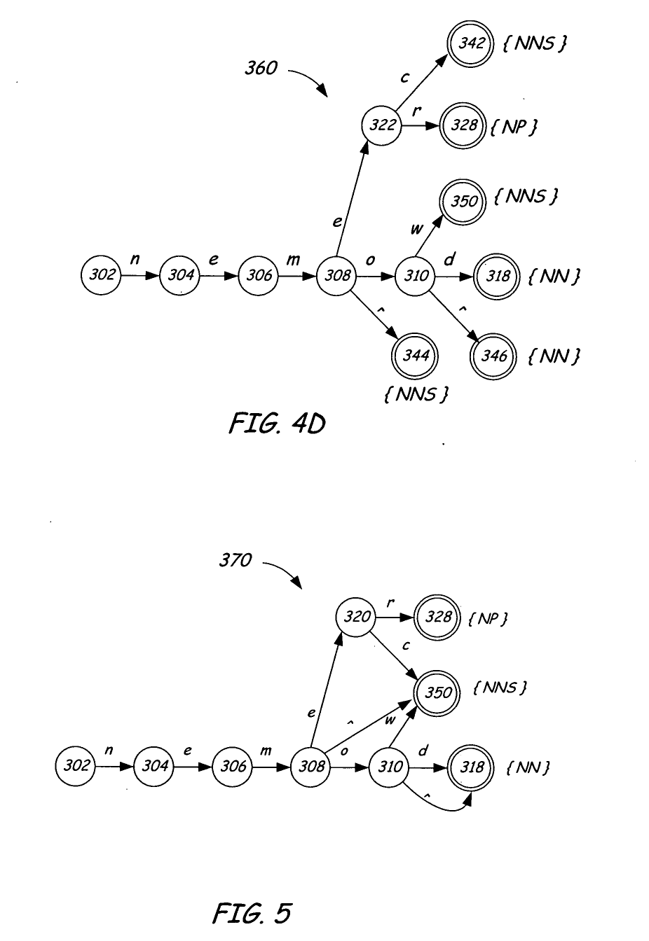

In one illustrative embodiment, generalizing the data structure at block 256 additionally includes further generalizing the data structures of the morphological data store 106 (shown in FIG. 1). FIG. 6 illustrates a data structure 400 that illustratively corresponds to data structure 370 but has been further generalized. Note that nodes in the data structure that are substantially similar to nodes in the data structure 370 are numbered similarly in the 400 series of numbers.

Nodes 408 and 410 are illustratively shown as terminal nodes with part of speech tags (shown as “{POS}” in FIG. 6) even though they do not point to an unambiguous result. Thus, an out of vocabulary word with a maximum suffix match that corresponds to either of the nodes 408 and 410 can be assigned a part of speech tag. In addition, because no word in the dictionary would actually have a maximum suffix that ended at node 408 or node 410, the only assignments at these nodes would be assignments for out-of-vocabulary words. Therefore, the part of speech data structure 400 provides unambiguous and precise results for every known word in the dictionary while also providing additional part of speech guessing for out of vocabulary words. While nodes 408 and 410 are the only nodes converted from a non-terminal node to a terminal node at this step, it should be understood that any, all, or none of the previously non-terminal nodes can be converted to a terminal node at this step without departing from the scope of the invention.

As discussed above, some of the termination nodes such as termination nodes 428 and 450 (which, of course, correspond to nodes 328 and 350 of FIG. 5) provide an for an unambiguous result. By contrast, other terminal nodes such as 408 and 410 do not. As an example, consider node 408. A word that matches only the pattern 402 through 408 is not only an out of vocabulary word, but the word does not match a pattern where only a single part of speech guess can be made. Nodes 410, 420 and 450 extend from node 408. Additional nodes extend from each of node 410 and 420. If each path that extends from node 408 were to be traversed, the paths return parts of speech identified as “NP”, “NNS”, and “NN”. A part of speech guess for an out of vocabulary word with a maximum suffix match from 402 through 408 (that is “men”) cannot be made without choosing at least one of the three part of speech tags provided.

In one illustrative embodiment, the part of speech tag guess for an out of vocabulary word is illustratively made by a union of all of the branches provided. Thus, for example, a word with a maximum matched suffix of “men” (that is, the path from nodes 402 to 408) is illustratively assigned each of the “NP”, “NNS”, and “NN” part of speech tags. Alternatively, the part of speech tag guess is illustratively made by an intersection of all of the branches provided.

In the particular example provided herein, a word with a maximum matched suffix of “men” (node 408) is illustratively assigned the intersection of nodes 410, 420, 450. Node 410 has branches that include the part of speech tags “NNS” and “NN”. Node 420 has branches that include part of speech tags “NNS” and “NP”. Node 450 has the “NNS” part of speech tag assigned to it. Since each of the nodes 410, 420, and 450 has an “NNS” tag, the intersection of these nodes is, in one illustrative embodiment, the “NNS” tag. Of course, because the nodes 410 and 420 do not, in and of themselves, have part of speech tags assigned to them, the intersection may be a null set.

Alternatively, each of the nodes 410 and 420 can be assigned part of speech tags in a manner similar to that described with respect to node 408 above. From those assignments, a union or intersection of the nodes can be used to assign one or more part of speech tags to node 408.

In yet another illustrative embodiment, node 408 is assigned a part of speech tag by calculating a relative frequency of each of the parts of speech that extend from node 408. For example, if it is determined that the NNS tag is the most frequent tag that extends from the various branches that extend form node 408, the NNS tag is illustratively assigned to the node 408. By assigning a single tag to node 408 that is most likely to be the correct part of speech based upon probability. This method can be especially useful in morphologically rich languages that have similar suffixes for words that are the same part of speech. Alternatively still, a node can be assigned more than one part of speech tag using the relative frequency method. For example, if two parts of speech tags have similar probabilities, both can be assigned to a particular node.

It should be appreciated that the assignment of part of speech tags to nodes that have subsequent paths extending from them can be accomplished using any of the methods discussed above. In addition, different nodes within the same graph can be assigned part of speech tags using different methods within the same finite-state model without departing from the scope of the discussion. Furthermore, some nodes need not be assigned a part of speech tag. For example, an out of vocabulary word having a maximum matching suffix of one or two or even more letters may not have a matching suffix long enough to make a reasonable part of speech tag guess.

Additional terminal nodes that do not provide unambiguous results can be very useful. Consider, as an example, the assignment of a set of POS classes to the state corresponding to the suffix “sion”. While not every out of vocabulary word having a suffix “sion” is a noun, it is likely that a dictionary of the English language would yield a high frequency of singular nouns. In addition, some words ending in “sion” can be both a singular noun or a verb. An example of such a word is the word “mission”. In most applications, the word mission is used as a singular noun. In some cases, however, the word mission is a verb. In any case, words ending in “sion” have a high probability (although not 100%) of being a singular noun.

One possible approach when encountering an out of vocabulary word that ends in “sion” is to assign both “NN” and a “VB” part of speech tags to the word. Another approach is to compare the relative probabilities of “sion”/VB vs. “sion”/NN for all words, and use one POS tag in the case where one POS tag is far more likely to be correct than the other. Having done that, we are now able to assign POS tag NN to every word with the longest matching suffix “sion”, such as “xsion”, assuming we did not have it in the original dictionary, and yet to retain correct results for all known words. By assigning a part of speech of singular noun to each of the out of vocabulary words, a large number of correct assignments can be made, even if some of the assignments are incorrect. In applications such as machine translation or grammar checking, such an assignment can be quite useful.

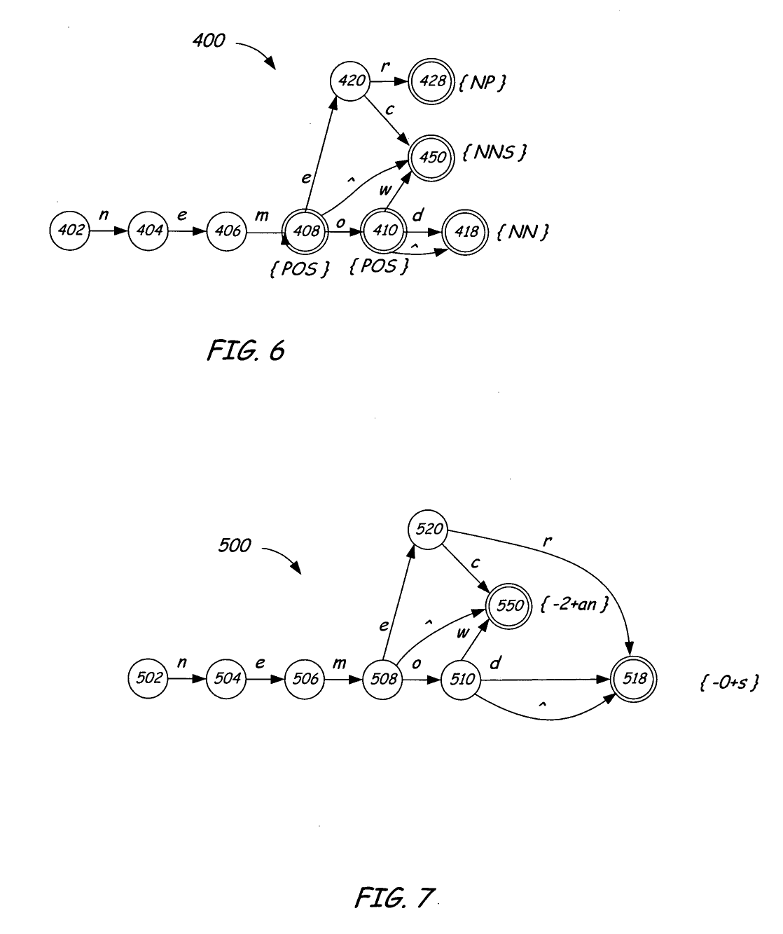

FIG. 7 is an illustration of word-form transformation data structures 500 associated with the dictionary in table 200 (shown in FIG. 8) according to one illustrative embodiment. The word-form transformation data structure 500 is constructed using the same types of procedures described above with respect to the part of speech data structure 370. Note that nodes in the data structure 500 that are substantially similar to nodes in the data structure 370 are numbered similarly in the 500 series of numbers. Terminal nodes such as nodes 518 and 550 are assigned a list of one or more inflections or transformation instructions to convert the input word to one or more inflections. Alternatively, nodes such as node 508, node 510, or node 520 can illustratively have one or more inflections or transformation instructions to convert an out of vocabulary word into one of the list of inflections. As discussed above, the list of inflections or transformation instructions at each non-terminal node can be determined as a function of an intersection, union, or probability function of nodes that extend from the non-terminal node.

FIG. 3B illustrates a method 270 of providing morphological information to a computer-implemented application. The method includes receiving an input signal indicative of a word, such as from an application 102 in FIG. 1. This is indicated by block 272. The method further includes selecting a piece of morphological class data from a finite-state automaton-based data structure (as is illustrated in block 274). The data structure is of the type shown in FIG. 1 and has morphological class data associated with at least a part of the word. In one embodiment, the morphological class data includes data indicative of a part of speech. Alternatively, the morphological class data can be any type of data, including data indicative of a word-form translation. The selected morphological class data is provided to the application, as is shown in block 276.

The embodiments discussed above are discussed with respect to English language implementations. Alternatively, and as referred to above, the data structures can be used in other language applications. In fact, in highly morphological languages the use of a data structures of the type described above can be highly advantageous. It should be appreciated that languages other than English can have different challenges for the data structures to overcome. For example, specific language phenomena such as reduplication and capitalization may need to be provided for in the creation of the data structures. In addition, in some languages, word structures require that the prefix change to form particular lexemes. Thus, pre-processing and post-processing of words may necessarily be undertaken to create data structures that can be easily traversed. The goal of such preprocessing is (along with the suffix text itself) to encode the important morphological information in the suffix of a word. The reverse transformations are needed to produce words readable for users. Below are some examples of these transformations.

| Phenomena | Word | Processing result |
|---|---|---|
| Reduplication: | adukan-adukanmuah | adukan2mukah |
| Prefixation: | memperadukan | adukan_memper |
| Prefixation + | memperadukan-adukanmuah | adukan2mukah_memper |
| Reduplication: | | |
| Capitalization | Apfel | apfel_{—} |

The processing results provided above can be added to a data structure and the morphological operator will naturally take the special language phenomena into account.

The embodiments discussed above provide important advantages. For example, with part of speech guessing, both known and unknown words using a single approach and a single data structure for both. By creating a single data structure that incorporates all the words in the dictionary and all possible unknown words into a finite-state automaton, the use of multiple structures used in a dictionary-based implementation can be avoided. Thus, it is not necessary to make additional analysis if a particular word is an out of vocabulary word.

In addition, the embodiments provides improved runtime efficiencies and improved memory usage as the data structures do not, on average, require traversal and storage of the whole word to get a correct match and the resultant data. Furthermore, because in many cases, only a portion of a word is stored, the memory usage is lower. In fact, the current embodiments require a data structure that is about half the size of the corresponding dictionary while still providing a 100 percent correct output for known words and a reasonably high rate of correct information for out of vocabulary words. In addition, the embodiments allow for a balance between precision and recall for out of vocabulary words as some morphological operations one may be more important than others may.

It should be understood that the generalization algorithms described in the embodiments are not limited to the word-form transformation or identification of POS tag classes. Alternatively or in addition, the algorithms discussed above can be applied to other classes of words as well. One example of a different type of class is language detection. In other words, each word can be assigned a language tag, which recognizes the language or languages in which a particular word may be used. In this case every word will be mapped into a set of language names to which it belongs, thus it will be possible to make word-based language detection and not to store all words.

FIG. 8 illustrates an example of a suitable computing system environment 600 on which embodiments of a system 100 for automated word-form transformation and part of speech tag assignment discussed above may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 8, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture. (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 8 illustrates operating system 634, application programs 635, other program modules 636, and program data 637. As an example, algorithms associated with the morphological data operator 104 can be stored or loaded into any of the computer storage media discussed above for execution thereof.

The computer 610 may also include other removable/non-removable volatile/nonvolatile computer storage media. By way of example only, FIG. 8 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650. The morphological data store 106 can be stored in any of the removable/non-removable volatile/nonvolatile computer storage media discussed above.

The drives and their associated computer storage media discussed above and illustrated in FIG. 8, provide storage of computer readable instructions, data structures, program modules and other data for the computer 610. In FIG. 8, for example, hard disk drive 641 is illustrated as storing operating system 644, application programs 645, including, for example, any of the applications 102 discussed above, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 8 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. This includes, without limitation the morphological data store 106 and/or the morphological operator 104. By way of example, and not limitation, FIG. 8 illustrates remote application programs 685, which can include for example, the applications 102 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of creating a data structure for use with a morphological algorithm, comprising:
creating a data structure having a plurality of paths that maps a plurality of words into a set of classes;
modifying the data structure to remove a portion of one or more of the paths that is not necessary to unambiguously map the words to the set of classes; and
storing the data structure on a tangible computer readable medium.

2. The method of claim 1, wherein creating a data structure includes creating paths having at least one node and wherein a node at an end of the path is associated with data related to the set of classes.

3. The method of claim 1, wherein creating a data structure includes mapping the dictionary into set of classes related to parts of speech.

4. The method of claim 1, wherein creating a data structure includes mapping the dictionary into set of classes related to inflections.

5. The method of claim 2, and further comprising:
modifying the data structure to associate data related to the set of classes to a node not at an end of the path.

6. The method of claim 5, wherein associating data to a node not at the end of path comprises:
associating class data that represents a union of class data associated with at least two other nodes.

7. The method of claim 5, wherein associating data to a node not at the end of path comprises:
associating class data that represents an intersection of class data associated with other nodes.

8. The method of claim 5, wherein associating data to a node not at the end of path comprises:
associating class data based upon a relative frequency of the class data associated with other nodes.

9. The method of claim 1, and further comprising:
processing a word to account for specific language phenomena; and
providing the processed word for the step of creating the data structure.

10. The method of claim 9, wherein processing the word includes accounting for at least one of reduplication, prefixation, and capitalization.

11. A method of providing morphological information to a computer implemented application, comprising:
receiving an input signal indicative of a word;
selecting a piece of morphological class data from the finite state automaton-based data structure that is mapped to a location in the data structure associated with at least a portion of the word; and
providing the piece of morphological class data to the application without accessing a dictionary.

12. The method of claim 11, wherein providing the piece of morphological class data includes providing data indicative of a part of speech.

13. The method of claim 11, wherein providing the piece of morphological data includes providing data indicative of a word-form transformation.

14. The method of claim 13, wherein providing data indicative of a word-form transformation comprises providing data indicative of an inflection.

15. The method of claim 13, wherein providing data indicative of a word-form transformation comprises providing data indicative of a base-form of the word.

16. The method of claim 11, wherein selecting a piece of morphological class data from the finite state automaton-based data structure includes selecting data associated with less than the entire word.

17. The method of claim 11, wherein searching the finite-state automaton-based data structure includes searching a finite-state automaton-based data structure based upon a dictionary of known words and wherein the input received is indicative of a word that is not a known word.

18. A tangible computer medium for storing a system adapted to perform automated morphological operations on an input, comprising:
a first finite state automaton-based data structure having a plurality of paths that maps a dictionary of words into a set of classes, wherein at least one of the paths is shorter than the word that is mapped to it;
a second finite state automaton-based data structure having a plurality of paths that maps a dictionary of words into a set of classes; and
an algorithm configured to access at least one of the first and second data structures to retrieve data related to the sets of classes.

19. The tangible computer medium of claim 18, wherein the first data structure includes paths having at least one node and wherein a node at an end of the path is associated with data related to the set of classes.

20. The tangible computer medium of claim 19, wherein a node not at an end of the path is associated with data related to the set of classes.
